(19) United States
(12) Patent Application Publication
(10) Pub. No.: US 2013/0100660 A1
(43) Pub. Date: Apr. 25, 2013

(54) MULTIPLE EXCITING LIGHT SYSTEM

(71) Applicant: HUNTINGTON BIOLOGICAL NUTRITION, INC., HSINCHU CITY (TW)

(72) Inventors: Kuan-Lin Lee, HSINCHU CITY (TW); Chen-Sheng Wu, HSINCHU CITY (TW); Chun-Hsien Kuo, HSINCHU CITY (TW)

(73) Assignee: HUNTINGTON BIOLOGICAL NUTRITION, INC., HSINCHU CITY (TW)

(21) Appl. No.: 13/629,892

(22) Filed: Sep. 28, 2012

(30) Foreign Application Priority Data
Oct. 19, 2011 (TW) 100137934

(51) Int. Cl. F21V 9/00

(52) U.S. Cl. 362/231

(57) ABSTRACT

A multiple exciting light system for a test of a biological sample labeled with fluorochrome includes a case, in which a sample table, a first light source module, a second light source module, and filter unit are provided. The sample table is provided in the case to put the biological sample thereon. The first light source module is provided in the case to emit visible light as a first light; and the second light source module is provided in the case to emit visible light or invisible light as a second light. The first light from the first light source module and the second light from the second light source module excite the fluorochrome in the biological sample at the same time to generate a third light with a third wavelength by fluorescence resonance superposition energy transfer.

The current application claims a foreign priority to the patent application of Taiwan No. 100137934 filed on Oct. 19, 2011.

### BACKGROUND OF THE INVENTION

1. Field of the Invention

The present invention relates generally to a light system, and more particularly to a multiple exciting light system for observation of biological samples in the biological test.

2. Description of the Related Art

With advancement in biotechnology, we pay much attention to test the biological sample, such as protein, cell, and deoxyribonucleic acid (DNA). In prior art, the biological sample is tested by fluorescence detection. In fluorescence detection, fluorochrome has an excitation state and an emission state to mark the specified molecules in the biological sample.

Take the DNA molecule for example, it is added in an electrophoresis solution, which includes buffer solution, such as TAE buffer, and gel, such as agarose gel electrophoresis (AGE) or polyacrylamide gel electrophoresis (PAGE). The electrophoresis solution is supplied with voltage to form gel electrophoresis and obtain a DNA gel. Next, the DNA gel is stained with fluorochrome, such as ethidium bromide (EtBr). Now, the DNA gel may be exposed to UV light to excite the fluorochrome to generate fluorescence so that researchers may observe the DNA in agarose gel or polyacryamide gels through fluorescence. However, UV light must be operated in a dark room. Besides, it is known that UV light is harmful to human skin. It is bad for the researchers who are exposed to the UV light for a long time in the test.

In conclusion, the present invention will introduce a multiple exciting light system to overcome the drawbacks as described above.

### SUMMARY OF THE INVENTION

The primary objective of the present invention is to provide a multiple exciting light system, which emit visible light and/or invisible light for observation of the biological sample in the biological test.

Another objective of the present invention is to provide a multiple exciting light system, which has a plurality of light sources in different locations to enhance the excitation of fluorochrome in biological sample.

According to the objectives of the present invention, the present invention provides a multiple exciting light system for a test of a biological sample labeled with fluorochrome, including a case, in which a sample table, a first light source module, a second light source module, and filter unit are provided. The case has a chamber. The sample table is provided in the chamber of the case to put the biological sample thereon. The first light source module is provided in the chamber of the case to emit a first light with a first wavelength, wherein the first light is visible light; and the second light source module is provided in the chamber of the case to emit a second light with a second wavelength, wherein the first light is visible light or invisible light. The first light from the first light source module and the second light from the second light source module excite the fluorochrome in the biological sample at the same time to generate a third light with a third wavelength by fluorescence resonance superposition energy transfer, FRET. The filter unit is provided in the chamber of the case above the sample table to filter noise of the third light out to form a clear third light.

In comparison with the prior art, the present invention provides the multiple exciting light system to emit visible light and/or invisible light. The visible and invisible light has multiple wavelengths which excites the fluorochrome -labeled biological sample to emit strong fluorescence. In an embodiment, the present invention further includes a filter unit to filter the light. In an embodiment, the present invention catches images before and after test to adjust brightness, white balance, or contrast of the biological sample's image.

### BRIEF DESCRIPTION OF THE DRAWINGS

FIG. 1 is a sectional view of the multiple exciting light system of a first preferred embodiment of the present invention;

FIG. 2 is a sketch diagram of the first preferred embodiment of the present invention, showing the arrangement of the first light source and the second light source;

FIG. 3 is a sectional view of the multiple exciting light system of a second preferred embodiment of the present invention;

FIG. 4 is a sketch diagram, showing the excitation of fluorochrome;

FIG. 5 is a sketch diagram, showing the generation of the third light;

FIG. 6 is a sectional view of the multiple exciting light system of a third preferred embodiment of the present invention;

FIG. 7 is a sectional view of the multiple exciting light system of a fourth preferred embodiment of the present invention;

FIG. 8 is a sectional view of the multiple exciting light system of a fifth preferred embodiment of the present invention;

FIG. 9 is a sectional view of the multiple exciting light system of a sixth preferred embodiment of the present invention;

FIG. 10 is a sectional view of the multiple exciting light system of a seventh preferred embodiment of the present invention; and

FIG. 11 to FIG. 14 shows the results of biological tests in different samples exposed under different light sources.

### DETAILED DESCRIPTION OF THE INVENTION

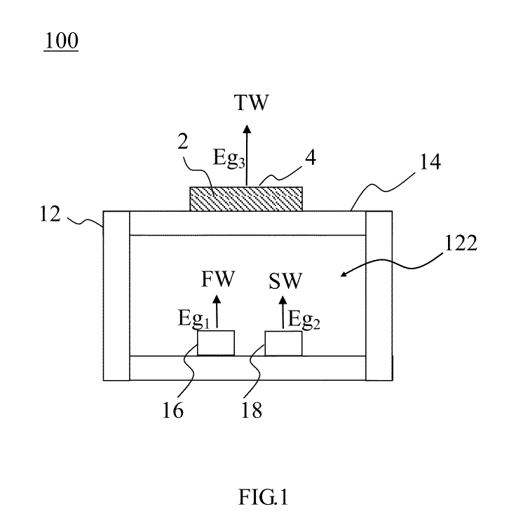

As shown in FIG. 1, a multiple light system 100 of the first preferred embodiment of the present invention is to excite fluorochrome 2 (so called fluorophore) added in a biological sample 2. The biological sample 2 may be gel electrophoresis of deoxyribonucleic acid (DNA), protein, or bio-materials.

The multiple exciting light system 100 includes a case 12, a sample table 14, a first light source module 16, and a second light source module 18. The case 12 forms a chamber 122 therein. The sample table 14 is provided in the chamber 122 of the case 12 to put the biological sample 4 thereon. The sample table 14 may be transparent or matted.

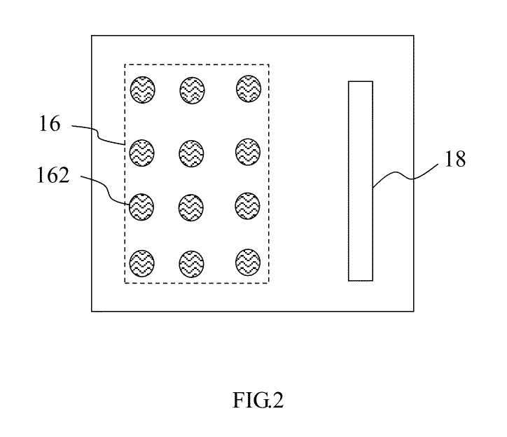

The first light source module 16 and the second light source module 18 are provided in the chamber 122 under the sample table 14 to emit the first light FW and the second light SW to the biological sample 4 through the sample table 14 respectively or in the same time. FIG. 2 shows an arrangement of the first light source module 16 and the second light source module 18 of an embodiment of the present invention.

The first light FW is visible light with a first wavelength. In other words, the first wavelength is in a range between 380 nm (purple) and 750 nm (red). In an embodiment, the first light FW is blue light, and the first wavelength is between 435 nm and 480 nm. The first light source module 16 includes a plurality of light sources 162, and the light sources 162 may be blue LEDs (light emitting diode) in the present invention.

The second light SW may be visible light or invisible light, and the second wavelength may be in a range of visible light's wavelength (380 nm and 750 nm) and invisible light's wavelength (280 nm (far ultraviolet) and 380 nm (near ultraviolet)), or it may be greater than 750 nm (infrared). For example, the second light source module 18 may be UV lamp, green light tube, or black light tube. In an embodiment, the second light SW is ultraviolet, and the second wavelength is between 250 nm and 400 nm, or the second light SW is green light, and the second wavelength is between 577 nm and 492 nm. The first and the second lights FW and SW excite the fluorochrome 2 in the same time, which generate a specified third light with a third wavelength by fluorescence resonance superposition energy transfer.

When the first light source module 16 and the second light source module 18 emit the first light FW and the second light SW to the fluorochrome 2 in the same time, the fluorochrome 2 absorbs a first energy Eg1 of the first light FW and a second energy Eg2 of the second light SW. Eg1 and Eg2 may be obtained from the equation: Eg=hv, wherein h is Planck constant (6.626×10⁻³⁴J·s) and v is frequency. After that, the fluorochrome 2 will be excited and generate the third light with a third energy Eg3 by fluorescence resonance energy transfer (FRET).

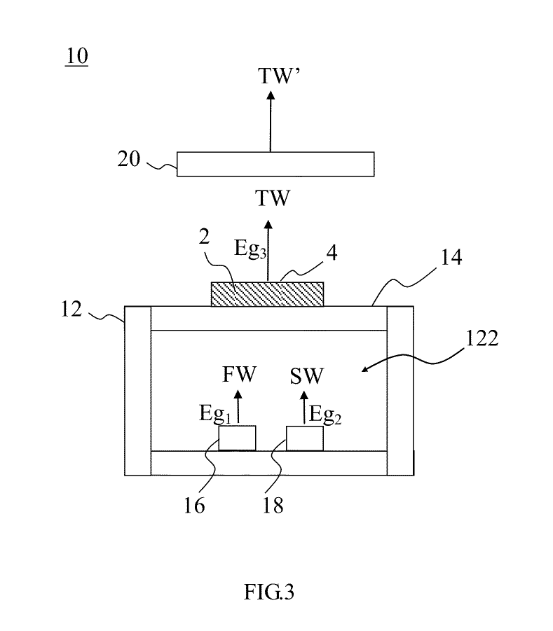

FIG. 3 shows a multiple exciting light system 10 of the second preferred embodiment of the present invention. In addition to the case 12, the sample table 14, the first light source module 16, and the second light source module 18, it further contains a filter unit 20. The filter unit 20 is provided in the chamber 122 of the case 12 above the sample table 14 to filter noise of the third light TW out to form a clear third light TW′. For example, the filter unit 20 may be a filter film in amber color. In other words, the wavelength of the clear third light TW′ is still within the wavelength range of the third light TW, and is closed to a single wavelength.

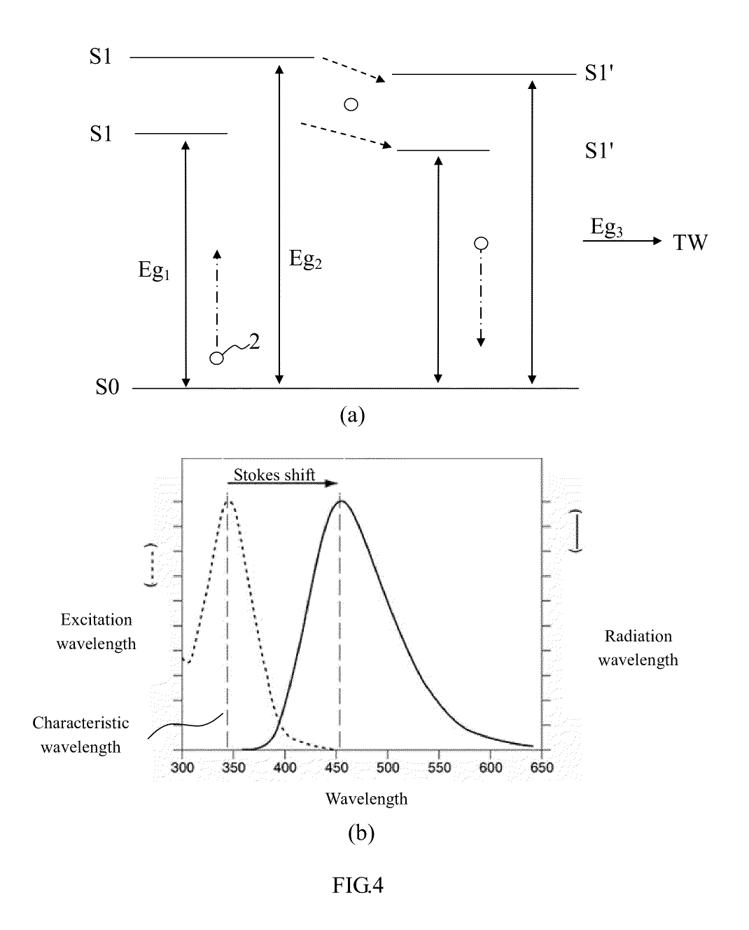

As shown in FIG. 4, when the fluorochrome 2 absorbs the first energy Eg1 and the second energy Eg2, photons of the fluorochrome 2 will be excited to an excitation state S1 from an emission state S0, as shown in FIG. 4(a). After several nano-seconds, the photons will fall to another excitation state S1′, which is slightly lower than the excitation state S1, and then fall back to the emission state S0 again so that the fluorochrome 2 emits the third light TW with the third energy Eg3. Because of energy loss and reduction of photon's energy, radiation wavelength is longer than excitation wavelength, and the difference therebetween calls Stokes shift. In other words, the wavelength of incident light is different from the wavelength of the fluorescence released from the fluorochrome 2. Besides, each fluorochrome 2 has a specified characteristic wavelength so that we may find a fluorescence emission maximum at a specified emission wavelength (the characteristic wavelength) in the emission spectrum of the fluorochrome 2, as shown in FIG. 4(b).

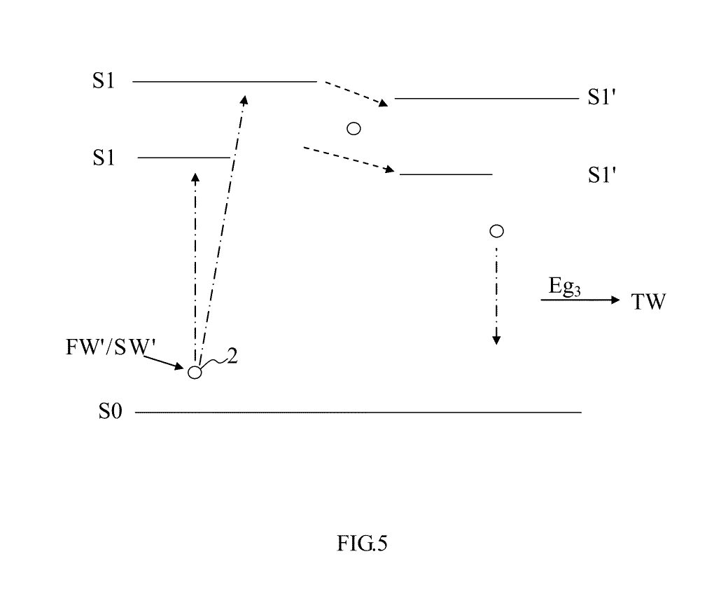

As shown in FIG. 5, the visible first light FW has a first characteristic wavelength FW′ to excite the fluorochrome 2 to emit the third light TW. For example, when we choose SYPRO RUBY to be the fluorochrome 2, the first light FW is blue light and the first wavelength is between 435 nm and 480 nm, and the first characteristic wavelength FW′ is about 470 nm. As a result, the fluorochrome 2 emits the third light TW of 610 nm after it absorbs the first characteristic wavelength FW′.

The invisible second light SW further has a second characteristic wavelength SW′ to excite the fluorochrome 2 to emit the third light TW. When we choose SYPRO Ruby to be the fluorochrome 2, the second light SW is UV light and the second wavelength is between 250 nm to 400 nm, and the second characteristic wavelength SW′ is about 290 nm. As a result, the fluorochrome 2 emits the third light TW of 610 nm after it absorbs the second characteristic wavelength SW′.

Both of the visible light (the first light FW) and the invisible light (the second light SW) may excite the fluorochrome 2 to emit the third light TW with the same wavelength (610 nm for example) in the same time. The third energy Eg3 of the third light TW is about equal to the sum of the first energy Eg1 and the second Eg2 of the first and the second characteristic wavelengths FW′ and SW′ by superposition and transfer of energy. In other words, when the fluorochrome 2 absorbs two kinds of energy, the intensity of fluorescence released from the fluorochrome 2 is much greater than that the fluorochrome 2 only absorbs single energy.

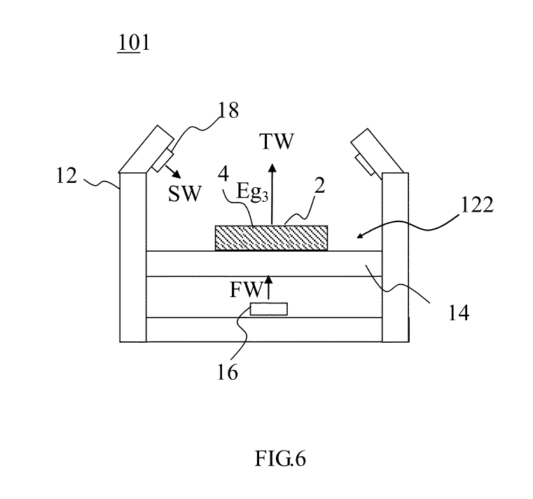

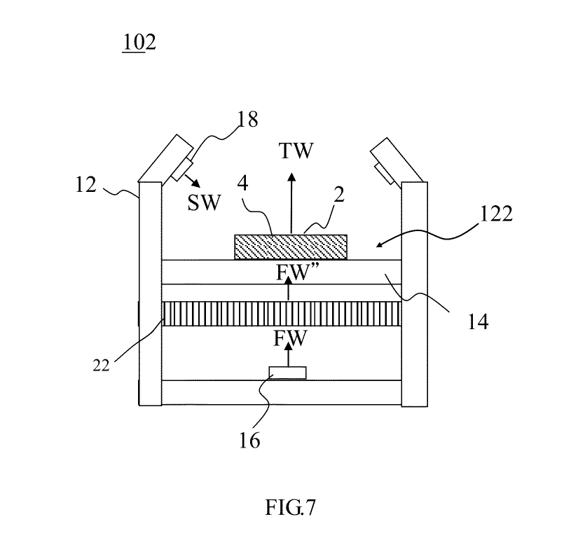

FIG. 6 shows a multiple exciting light system 101 of the third preferred embodiment of the present invention, including the case 12, the sample table 14, the first light source module 16, the second light source module 18, and the filter unit 20, the same as above. In the present embodiment, the first light source module 16 is under the sample table 14, and the second light source module 18 is above the sample table 14. The second light source module 18 directly emits the second light SW to the biological sample 4 on the sample table 14 in a direction diverging from a normal of the sample table 14. In the fourth preferred embodiment of the present invention, a multiple exciting light system 102 further includes a diffusion unit 22 above the first light source module 16 to diffuse the first light FW from the first light source module 16 and form a surface first light FW′ as shown in FIG. 7.

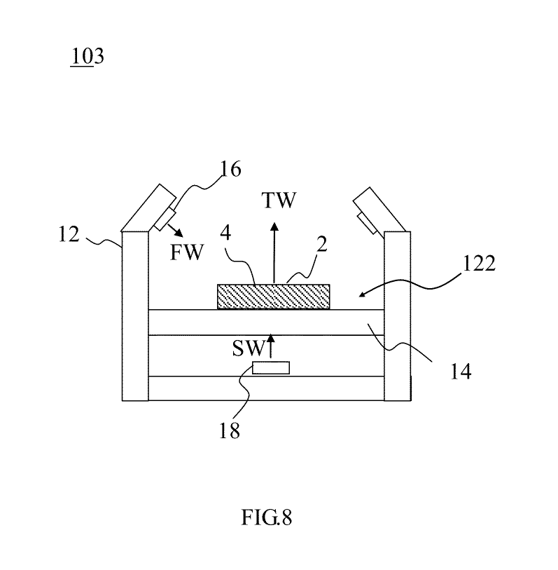

FIG. 8 shows a multiple exciting light system 103 of the fifth preferred embodiment of the present invention, in which the second light source module 18 is under the sample table 14 and the first light source module 16 is above the sample table 14. The first light source module 16 emits the first light FW directly to the biological sample 4 on the sample table 14 in a direction diverging from a normal of the sample table 14.

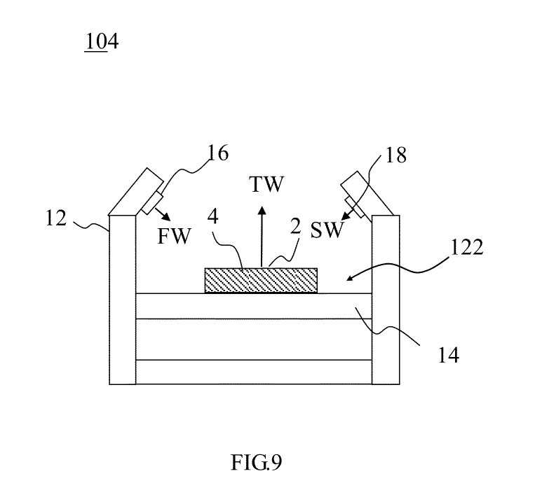

As shown in FIG. 9, a multiple exciting light system 104 of the sixth preferred embodiment of the present invention provides both the first and the second light source modules 16, 18 above the sample table 14 to emit the first light FW and the second light SW directly to the biological sample 4 on the sample table 14 in directions diverging from a normal of the sample table 14.

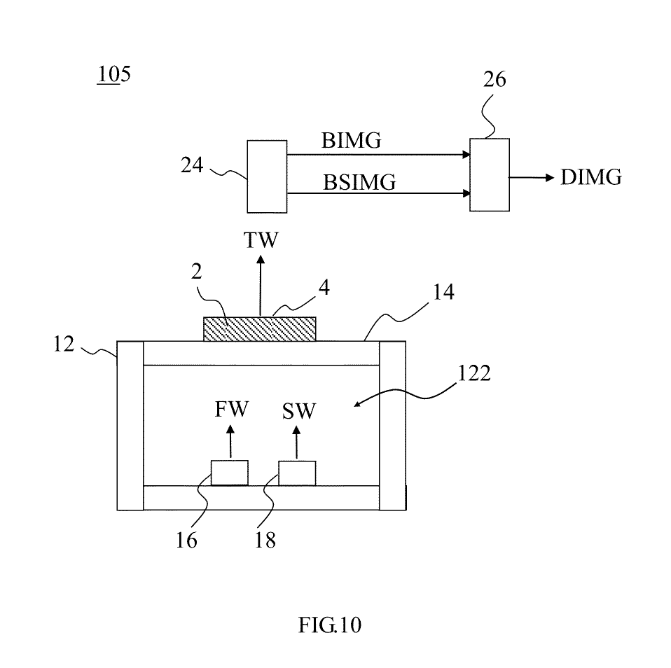

FIG. 10 shows a multiple exciting light system 105 of the sixth preferred embodiment of the present invention. Besides the case 12, the sample table 14, the first light source module 16, the second light source module 18, and the filter unit 20, it further includes an image capture unit 24 above the filter unit 20 to catch images through the filter unit 20. The image capture unit 24 may catch a background image BIMG which is taken when the biological sample 4 is not put on the sample table 14 yet, and a biological sample image BSIMG which is taken when the biological sample 2 has been put on the sample table 14. The multiple exciting light system 105 further includes a comparison unit 26 connected to the image capture unit 24 to compare the biological sample image BSIMG with the background image BIMG and to form a detection image DIMG according to the comparison result. The detection image DIMG shows the difference between the biological sample image BSIMG and the background image BIMG. The detection image DIMG may show the difference of brightness, white balance, or contrast.

Hereafter, we provide several test results to show the performance of the multiple exciting light system of the present invention in the biological test. In the following tests, gel electrophoresis of DNA and sodium dodecyl sulfate polyacrylamide gel electrophoresis (SDS-PAGE) is selected.

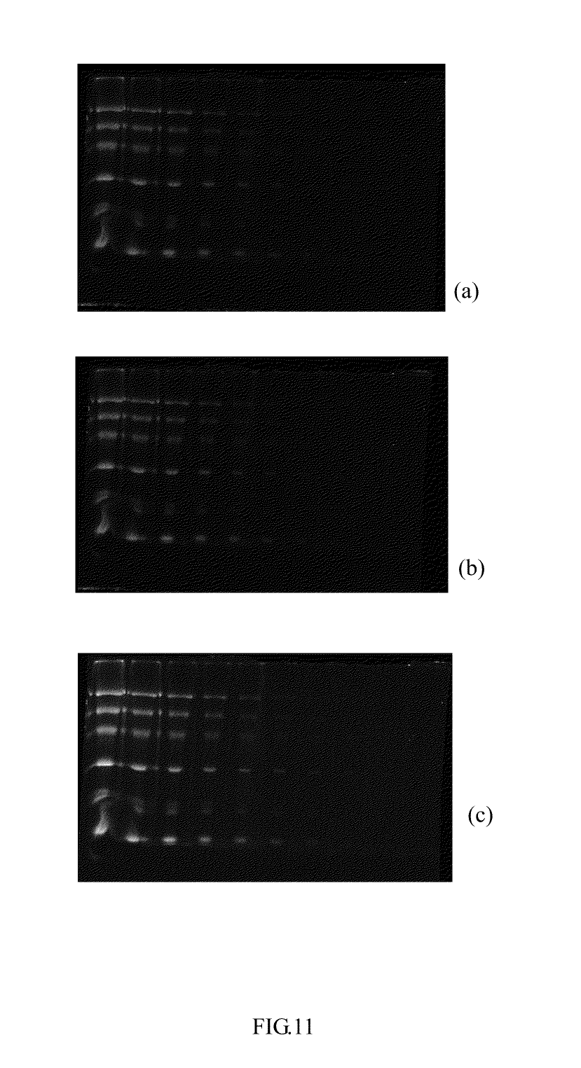

In the first control group, serially diluted protein molecular weight markers are loaded on SDS-PAGE. In the first lane, ten microliters of protein molecular weight markers are loaded. In the second lane, five microliters of protein molecular weight markers are loaded. In the third lane, two point five microliters of protein molecular weight markers are loaded. The following lane works in the same way as the previous. Besides, SDS-PAGE is stained by SYPRO Ruby. FIG. 11(a) shows the SDS-PAGE of the first control group exposed to single UV light; FIG. 11(b) shows the SDS-PAGE of the first control group exposed to single blue light; and FIG. 11(c) shows the SDS-PAGE of the first control group exposed to blue light and UV light. The result shows that SDS-PAGE in FIG. 11(c) is clearer for observation than FIG. 11(a) and FIG. 11(b).

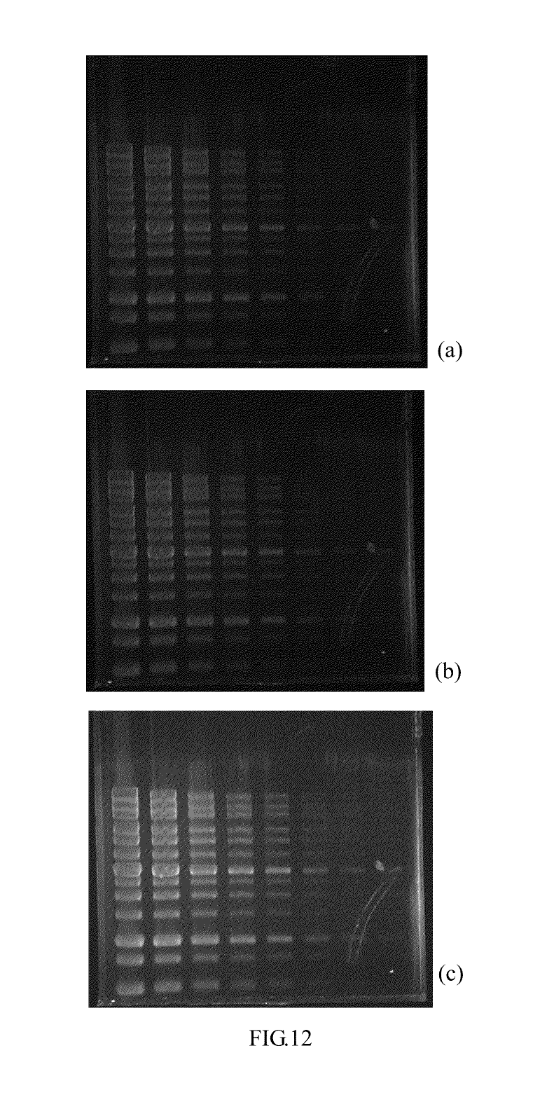

In the second control group, serially diluted DNA are subjected to electrophoresis on agarose gel lanes. In the first lane, five hundred nanograms of DNA are loaded. In the second lane, two hundred and fifty nanograms of DNA are loaded. In the third lane, two hundred and twenty five nanograms of DNA are loaded. The following lane works in the same way as the previous. Besides, DNA gel is stained by SYBER Green I. FIG. 12(a) shows the DNA gel of the second control group exposed to single UV light; FIG. 12(b) shows the DNA gel of the second control group exposed to single blue light; and FIG. 12(c) shows the DNA gel of the second control group exposed to blue light and UV light. The result shows that DNA gel in FIG. 12(c) is clearer for observation than FIG. 12(a) and FIG. 12(b).

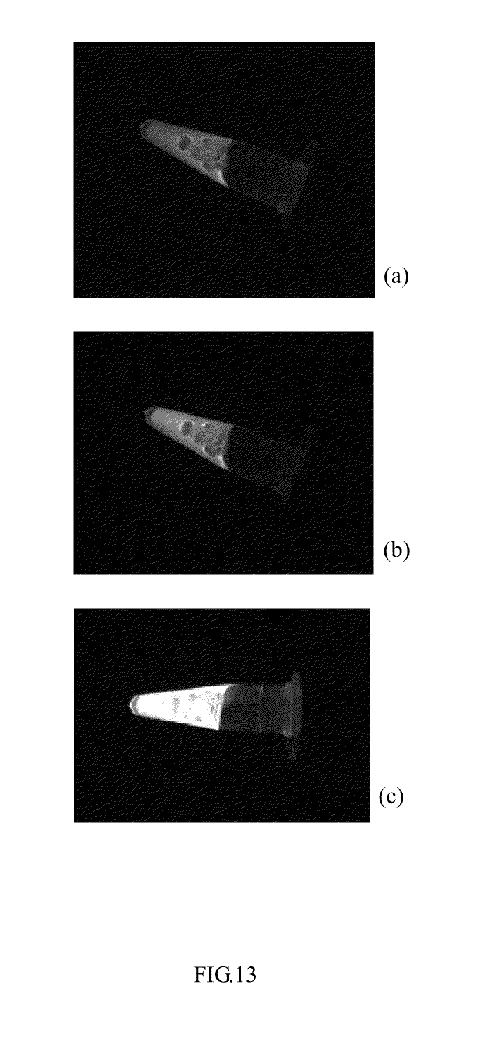

In the third control group, one hundred micrograms of bovine serum albumin (BSA) is stained with SYPRO Ruby in a small and transparent tube. FIG. 13(a) shows the BSA of the third control group exposed to single UV light; FIG. 13(b) shows the BSA of the third control group exposed to single blue light; and FIG. 13(c) shows the BSA of the third control group exposed to blue light and UV light. The result shows that BSA in FIG. 13(c) is clearer for observation than FIG. 13(a) and FIG. 13(b).

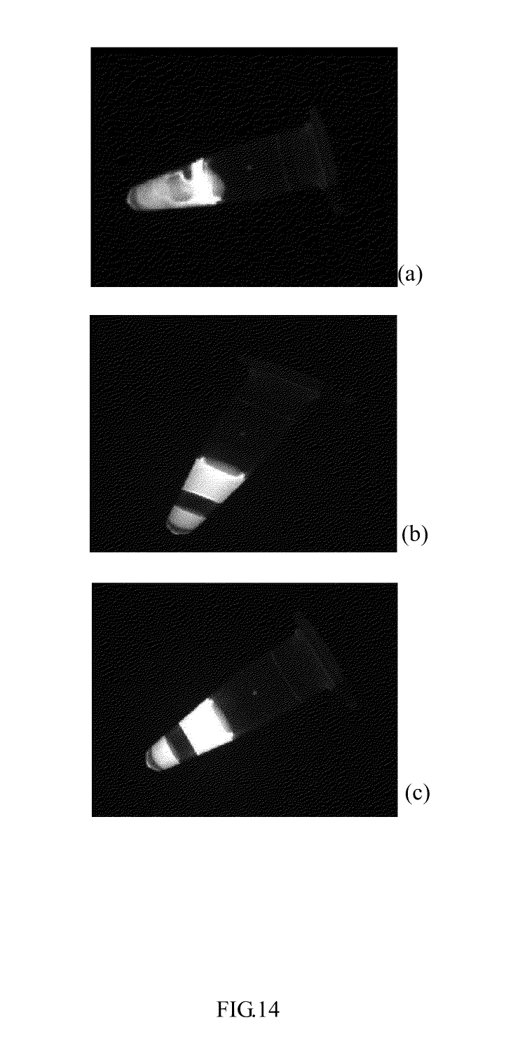

In the fourth control group, ten micrograms of DNA is stained with SYBER Green I in a small and transparent tube. FIG. 14(a) shows the DNA of the fourth control group exposed to single UV light; FIG. 14(b) shows the DNA of the fourth control group exposed to single blue light; and FIG. 14(c) shows the DNA of the fourth control group exposed to blue light and UV light. The result shows that DNA in FIG. 14(c) is clearer for observation than FIG. 14(a) and FIG. 14(b). The present invention provides the multiple exciting light system to emit visible light and invisible light in the biological test, so that fluorochrome in the biological sample is excited for fluorescence resonance energy transfer to generate a specified fluorescence. The present invention further provides the filter unit to filter the noise out and enhance the signal of the biological sample. The present invention further catches the image before and after test to adjust the brightness, white balance, or contrast of the image of biological sample in accordance with the difference between the images.

The description above is a few preferred embodiments of the present invention and the equivalence of the present invention is still in the scope of claim construction of the present invention.

What is claimed is:

1. A multiple exciting light system for a test of a biological sample labeled with fluorochrome, comprising:
a case having a chamber;
a sample table provided in the chamber of the case to put the biological sample thereon;
a first light source module provided in the chamber of the case to emit a first light with a first wavelength, wherein the first light is visible light; and
a second light source module provided in the chamber of the case to emit a second light with a second wavelength, wherein the first light is visible light or invisible light;
wherein the first light from the first light source module and the second light from the second light source module excite the fluorochrome in the biological sample at the same time to generate a third light with a third wavelength.

2. The multiple exciting light system as defined in claim 1, further comprising a filter unit in the chamber of the case, wherein the third light emits to the filter unit to be filtered.

3. The multiple exciting light system as defined in claim 1, wherein the first light source module has a plurality of light sources.

4. The multiple exciting light system as defined in claim 3, wherein the light sources of the first light source module are light emitting diodes.

5. The multiple exciting light system as defined in claim 4, further comprising a diffusion unit in the chamber of the case to diffuse the first light from the first light source module.

6. The multiple exciting light system as defined in claim 3, wherein the first light has a first characteristic wavelength to excite the fluorochrome to generate the third light.

7. The multiple exciting light system as defined in claim 6, wherein the first wavelength of the first light is in a range between 435 nm and 480 nm.

8. The multiple exciting light system as defined in claim 7, wherein the fluorochrome is excited by the first light to generate the third light with the third wavelength of 610 nm while the first characteristic wavelength of the first light is 470 nm.

9. The multiple exciting light system as defined in claim 1, wherein the second light has a second characteristic wavelength to excite the fluorochrome to generate the third light.

10. The multiple exciting light system as defined in claim 9, wherein the second wavelength of the second light is in a range between 250 nm and 400 nm.

11. The multiple exciting light system as defined in claim 10, wherein the fluorochrome is excited by the second light to generate the third light with the third wavelength of 610 nm while the first characteristic wavelength of the first light is 290 nm.

12. The multiple exciting light system as defined in claim 11, wherein the second light source module has UV lamp, green light tube, or black light tube.

13. The multiple exciting light system as defined in claim 12, wherein the sample table is transparent or matted.

14. The multiple exciting light system as defined in claim 13, wherein the first light source module and the second light source module are under the sample table to emit the first light and the second light to the biological sample through the sample table.

15. The multiple exciting light system as defined in claim 13, wherein one of the first light source and the second light source is under the sample table, and the other one is above the sample table.

16. The multiple exciting light system as defined in claim 15, wherein the one of the first light source and the second light source above the sample table directly emits the light to the biological sample in a direction diverging from a normal of the sample table.

17. The multiple exciting light system as defined in claim 13, wherein both of the first light source and the second light source are above the sample table to directly emit the first light and the second light to the biological sample in directions diverging from a normal of the sample table.

18. The multiple exciting light system as defined in claim 2, further comprising an image capture unit above the filter unit to catch images through the filter unit, wherein the images include a background image which is taken when the biological sample is not put on the sample table yet, and a biological sample image which is taken when the biological sample is put on the sample table.

19. The multiple exciting light system as defined in claim 18, further comprising a comparison unit connected to the image capture unit to compare the biological sample image with the background image to form a detection image.

20. The multiple exciting light system as defined in claim 19, wherein the detection image shows a difference of brightness, white balance, or contrast.

21. The multiple exciting light system as defined in claim 2, wherein the filter unit is an amber filter.

22. The multiple exciting light system as defined in claim 1, wherein the biological sample is gel electrophoresis.
